(19) United States
(12) Patent Application Publication
(10) Pub. No.: US 2026/0370881 A1
(43) Pub. Date: Nov. 19, 2026

(54) ADAPTIVE BUDGET CONTROL FOR ENTROPY CODING IN VIDEO CODING

(71) Applicant: DOLBY LABORATORIES LICENSING CORPORATION

(72) Inventors: Thuong Nguyen Canh, San Jose, CA (US); Peng Yin, Ithaca, NY (US)

(73) Assignee: DOLBY LABORATORIES LICENSING CORPORATION, (omitted)

(21) Appl. No.: 19/680,981

(22) Filed: May 18, 2026

Related U.S. Application Data
(60) Provisional application No. 63/808,434, filed on May 19, 2025.
(60) Provisional application No. 63/821,140, filed on Jun. 10, 2025.

(51) Int. Cl. H04N 19/61; H04N 19/186; H04N 19/70

(52) U.S. Cl. CPC H04N 19/61; H04N 19/186; H04N 19/70

(57) ABSTRACT

Methods and systems are described for coding and decoding scaled transform coefficients in video coding. Given a context-bin budget to switch between context mode coding and bypass mode coding of the transform-block coefficients, methods to manage the context-bin budget include: separate context-bin budgets for coding luma and chroma coefficients, and adaptive budget control for the context-based coding of the significant flag.

### CROSS-REFERENCES TO RELATED APPLICATIONS

This application claims the benefit of priority from U.S. Provisional Patent Application No. 63/821,140, filed on Jun. 10, 2025, and U.S. Provisional Patent Application No. 63/808,434, filed on May 19,2025, each of which is incorporated by reference in its entirety.

### TECHNOLOGY

The present document relates generally to images and video coding. More particularly, embodiments of the present invention relate to adaptive budget control for entropy coding in video coding.

### BACKGROUND

In 2020, the MPEG group in the International Standardization Organization (ISO), jointly with the International Telecommunications Union (ITU), released the first version of the Versatile Video Coding Standard (VVC), also known as H.266 (Ref. [1]). More recently, the same group has been working on the development of the next generation coding standard that provides improved coding performance over existing video coding technologies. As part of this investigation, new coding techniques are also examined.

As appreciated by the inventors here, improved techniques for video coding are desired, and they are described herein.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not be assumed to have been recognized in any prior art on the basis of this section, unless otherwise indicated.

### BRIEF DESCRIPTION OF THE DRAWINGS

An embodiment of the present invention is illustrated by way of example, and not in way by limitation, in the figures of the accompanying drawings and in which like reference numerals refer to similar elements and in which:

FIG. 1 depicts an example process for context-bin-budget control for residual transform coding according to prior art;

FIG. 2 depicts an example process of context-bin-budget control for residual transform coding based on the number of non-zero transform coefficients, according to an embodiment of this invention;

FIG. 3 depicts an example of context-bin-budget control for residual transform coding with separate luma and chroma context-bin budgets, according to an embodiment of this invention;

FIG. 4A and FIG. 4B depict an example process of a two-tier context-bin-budget control for residual transform coding, according to an embodiment of this invention; and

FIG. 5A and FIG. 5B depict an example process for context-bin-budget control for residual transform coding using a separate context-bin budget for processing the significant flag, according to an embodiment of this invention.

### DESCRIPTION OF EXAMPLE EMBODIMENTS

Example embodiments that relate to coding transform coefficients in video coding are described herein. In the following description, for the purposes of explanation, numerous specific details are set forth in order to provide a thorough understanding of the various embodiments of the present invention. It will be apparent, however, that the various embodiments of the present invention may be practiced without these specific details. In other instances, well-known structures and devices are not described in exhaustive detail, in order to avoid unnecessarily occluding, obscuring, or obfuscating embodiments of the present invention.

### SUMMARY

Example embodiments described herein relate to coding and decoding scaled transform coefficients in video coding. To improve throughput without compromising coding performance, a variety of new methods for managing the context-bin budget are proposed.

In a first embodiment, the total context-bin budget is adjusted based on the number of non-zero coefficients instead of using a budget limit based on the number of transform coefficients in the non-zero-out region of a transform block.

In a second embodiment, separate context-bin budgets are determined for coding luma and chroma coefficients. These embodiments can be further modified by a) applying a two-tier budget control that reserves a separate secondary context budget for the significant (sig) flag once a primary context-bin budget is consumed, or b) maintaining a separate significant flag (sig) bin-context budget, to guarantee that the significant flag is always context encoded.

### Transform Coefficient Coding in VVC

In modern image and video coding standards, given blocks of spatial data (e.g., the original pixel data or residuals), the coding process applies to them a frequency transform (e.g., the discrete cosine or sine transforms, and the like) to convert them into a frequency domain and generate transform coefficients. Next, the transform coefficients are quantized using a quantization parameter (QP) to generate quantized (or scaled) transform coefficients. Then, the quantized transform coefficients are encoded using a lossless encoder (e.g., Context Adaptive Arithmetic Coding-CABAC) to form a coded bitstream. Given that that quantized transform coefficients represent a significant part of the coded bitstream, it is imperative to code them as efficiently as possible.

As used herein, the terms “transform coding” or “transform coefficient coding” denote a process to binarize and encode the quantized transformed coefficients. Given a transformed residual of a given Transform Block (TB) of size W×H, its quantized coefficients, also referred to as levels, are grouped into a Coefficient Block (CB) of size B_{w}×B_{H}. The CB size is adaptively set based on the TB size. Levels are processed in a fixed, inverse z-scan order, of CB, and inside each CB.

To encode these transform coefficients, several scan steps are performed (Ref. [2]).
1) A Coded Block Flag (CBF) is signaled to indicate whether a Transform Block (TB) includes any nonzero level;
2) If CBF is 1, the last non-zero coefficient is encoded via its x and y coordinates in the forward z-scan order;
3) Starting from the last non-zero coefficient, the transformed coefficients (levels) are processed in a reverse scan order in each CB;
4) For each CB, an sb_coded_flag is used to indicate whether a CB includes any non-zero levels. Within a CB, levels are processed following a reverse scan order;
5) Each level is binarized with multiple scans, where a level can be represented by a sign bit (sign), a significant (sig) bit, greater than one (gt_1), parity (par), greater than three (gt_3) bits, and the non-binary remainder (rem) as follows:

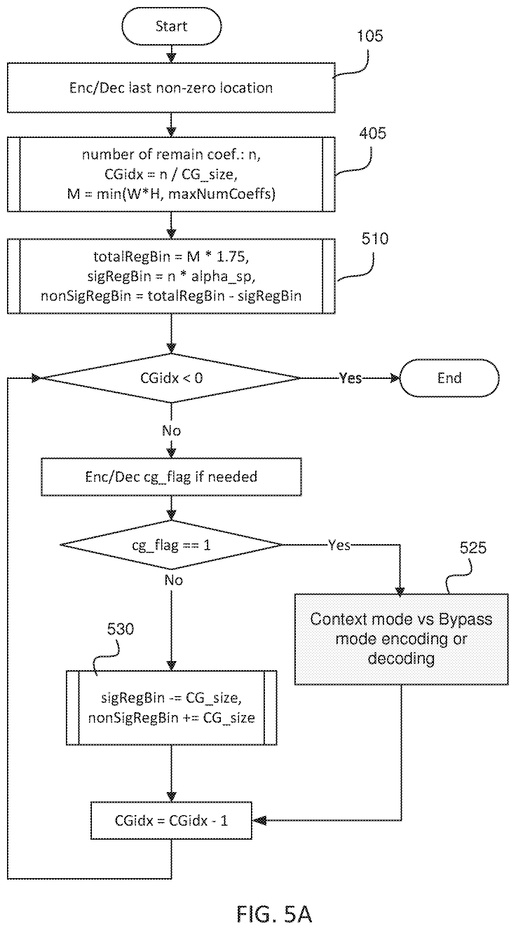

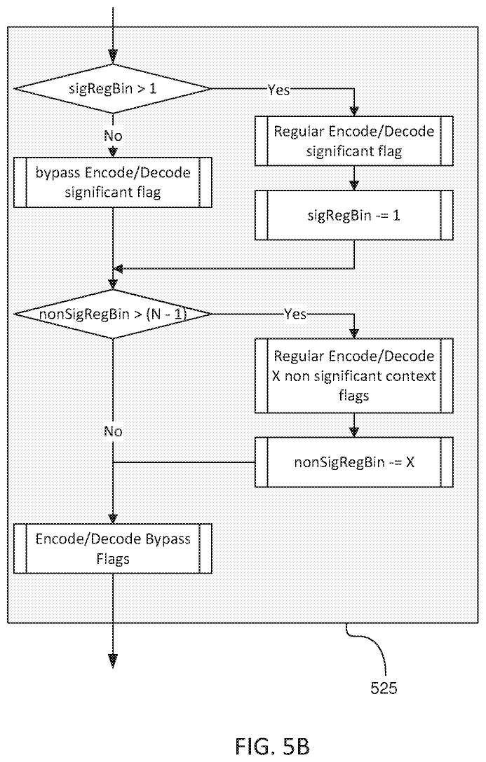

abs_coeff_level=sig+gt_1+par+2*(gt_3+rem). (1)
6) For a bin with a regular coded mode, a local template is used for context modeling updates (e.g., see FIG. 5 in Ref. [2]).

For example, in VVC, the transform coefficient 9 can be encoded as: sig=1, gt_1=1, par=1 (odd number), gt_3=1, rem=2.

In VVC, level coding is performed using a multi-pass approach:
Pass 1 applies context coding for sig, gt_1, par, and gt_3
Pass 2-1 encodes the remainder coefficient magnitude after pass 1. To control the throughput of residual coding, a budget constraint is defined as the maximum allowed context coded bins in Pass 1 as

totalRegBin=min(width*height,maxNumCoeff)*1.75=M*R, (2)

where the anchor size M=min(width*height, maxNumCoeff), maxNumCoeff denotes the maximum number of coefficients in the maximum transform block size, and a scaling factor R is set 1.75. This budget is allocated based on the assumption that one coefficient is encoded with a maximum of three context coded flags of sig, gt_1, and gt_3. This budget limit is fixed and is identical for both luma and chroma transform blocks.
After the budget is spent, in Pass 2-2, transform coefficients are encoded with an exponential Golomb code without any flags.
Finally, the sign bit is encoded in bypass mode in Pass 3.
Note 1: in entropy coding, bypass encoding is a process where one applies arithmetic coding without context modeling and updating the probability model (or, one applies a fixed probability model). It is very fast encoding, unlike context-based encoding which requires complex context switching/loading and updates for every bit. However, using bypass coding may reduce the coding efficiency. Thus, it is beneficial to apply bypass encoding intelligently to improve throughput without compromising the coding performance.
Note 2: while the budget constraint is defined in the encoder, for proper decoding, the decoder needs to maintain its own budget to know when to transition from context mode to the bypass mode. So, embodiments described herein are applicable to both video encoding and decoding.

After the development of VVC, the JVET group started work on an enhanced compression model (ECM). ECM made several improvements in transform coefficient by improving the probabilistic model of CABAC with improved context initialization, with a few notable changes. First, the absolute level is extended to N+1 flags (where, in practice, N is set to 7). Then, the level reconstruction is updated as

abs_coeff_level=sig+gt_1+gt_2+ . . . +gt_n+par+2* rem. (3)

To constraint the throughput, only sign, gt_1, gt_2, gt_3, and gt_4 are context-coded. Other binary flags like gt_5, gt_6, and gt_7 are bypass encoded. Additionally, ECM maintains the same context budget limit as in Eq. (2) for coefficient level coding but introduces additional context coded bins for sign prediction (Ref. [4]).

VVC introduces Transform Skip Residual Coding (TSRC), in which residuals can also be encoded with a transform skip mode with some modifications compared to regular transform coding. A transform skip can be represented by a sign bit, gt_1, gt_2 and remainder (rem) as:

abs_coeff_level=sig+gt_1+gt_2+par+2*(gt_4+gt_6+gt_8+rem). (4)

The multi-pass encoding is the same as in transform-residual coding, with the same context coded budget. Once the budget is over, the abs_coeff_level is encoded directly with an exponential Golomb code with index 0. In ECM, transform skip residual coding is the same as in VVC.

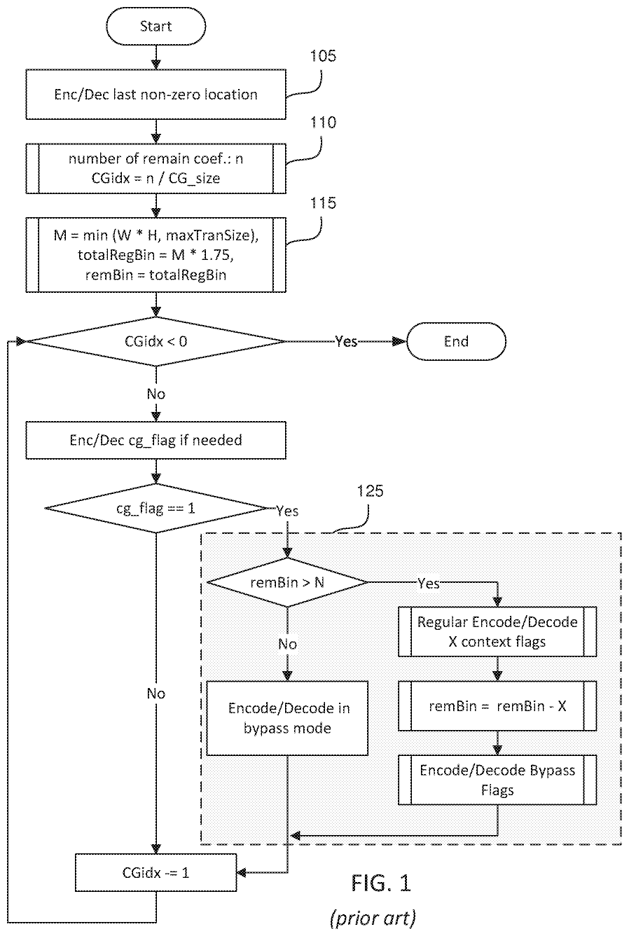

FIG. 1 depicts an example simplified process for budget control for residual transform coding. Note that the process applies to both encoding and decoding, thus, while in this figure or subsequent figures specific steps may be discussed in the context of encoding, without limitation, the same steps are applicable during decoding as well. Staring with encoding of the last non-zero location (105), in step 110, given n remaining coefficients to be coded, a coefficient group index (CGidx) is initialized to n/CG_size, where CG_size denotes the size of the coefficient group (CG), e.g., 16. Next (115), the total budget (totalRegBin) is computed. The remaining steps describe how each of the n coefficients is encoded by iterating until CGidx<0. The cg_flag, if available, denotes whether the whole coefficient group has at least one non-zero coefficient to be coded (cg_flag=1) or all are zero (cg_flag=0). If cg_flag=0, then entropy and bypass coding (125) are skipped.

In step 125 (coefficient group coding or decoding), each coefficient in the coefficient group is processed using either context mode or bypass mode, as follows. In step 115 a remBin value was initialized with the whole budget. In 125, N denotes the threshold to terminate context-based processing. For example, in VVC N=4 and in ECM N=7. As long as remBin>N, encoding is performed using context coding or bypass encoding depending on the flag type. When context coding is used, then the remBin value is reduced as needed by X, which denotes the number of predetermined contexts to be used for each coefficient to be coded. When remBin≤N, then all subsequent processing is performed in bypass mode.

In order to improve budget management in TSRC, the following proposals were made. In Ref. [6], once the regular budget is over it was proposed to binarize abs_coeff_level as

abs_coeff_level=sig+par+2*rem. (5)

Ref [6] also proposed to always context-encode the sig flag, which increases the budget limit beyond Eq. (2). To maintain the same budget as Eq. (2), Ref. [7] proposed to encode the sig flag in bypass mode once the budget is over. Ref. [7] also proposed to use Golomb coding with index 1 instead of index 0 for encoding the remainder (rem).

While the current transform coding and entropy coding tools perform well in VVC and ECM, the current design is more focused on low bit rates with small values of transformed coefficients and is rather inefficient to deal with high bitrates. Additionally, CABAC is constrained with the maximum number of contexts being updated before going to an all bypass encoding mode. In practice, this situation could happen frequently for large transform values and/or high bitrates. At high bitrate or low/very low QPs, the quantized transform residuals are in general large. Even though ECM residual coding has increased to 8 the context coded flags per transformed coefficients, it still uses the same budget control as VVC. Therefore, ECM becomes less efficient for encoding at high bitrates.

In addition, the new method in ECM gives higher priority to the significant flags. This shows improvement in performance but significantly increases the context coded bins over the context budget.

### Improved Techniques for Budget Allocation

Example embodiments of this invention propose methods to improve the budget allocation with multiple approaches. It is proposed to:
1) Modify the total budget (totalRegBin) by adjusting an anchor size M based on the number of non-zero coefficients, instead of using a budget limit based on the number of transform coefficients in the non-zero-out region of a transform block.
2) Determine separate budgets for luma and chroma, by adjusting the initial total budget using a luma budget scaling factor. In general, luma has larger residual values, thus coding efficiency should benefit from a higher luma context budget.
3) Apply adaptive budget control while maintaining the same total budget (totalRegBin) with
   a two-tier budget control that reserves a separate context budget for the sig flag once the regular context budget is consumed.
   A separate sig flag context budget to guarantee that the significant flag is always context encoded.

The proposed methods are applicable to both transform residual coding and transform skip residual coding in video coding. Proposed methods 1 and 2 can be combined with the budget control in method 3.

### Adjust the Total Context Budget Based on Non-Zero Coefficients

Problem: From Eq. (2), the budget is allocated based on the number of transform coefficients in the non-zero-out region of a transform block. For a larger transform block, the block is zeroed out to maintain the maximum transform block size, which is used to derive the budget. For example, for a CB of say 128×128, the actual transform size will be 64×64, and the rest of the coefficients will be forced to be zero.

Proposal 1. It is believed that the context-bin budget should also depend on the number of non-zero coefficients and not just the maximum transform block size. In an embodiment, it is proposed to allocate the budget based on the actual non-zero output coefficients of the current transform block. The number of the non-zero location could be inferred based on the location of the last non-zero coefficient. Assuming the number of coefficients to be encoded after knowing the last non-zero coefficient and the scan order is n<M, it is proposed to allocate the totalBudget after signaling the last non-zero coefficient as

totalRegBin=n*R, (6)

as n is smaller than M, especially using larger TBs and lower bit rates.

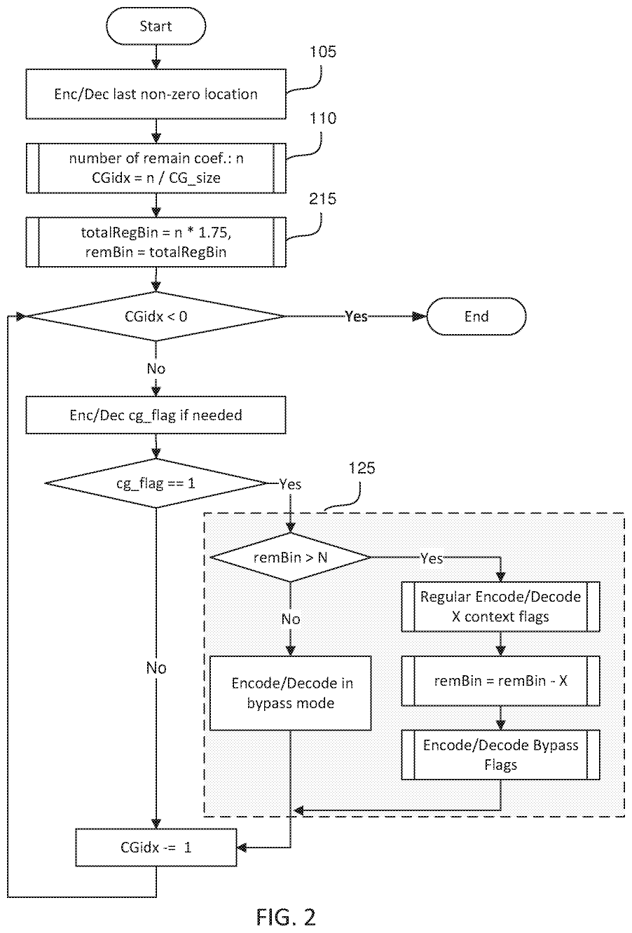

FIG. 2 depicts an example process for budget control in transform coding based on the number of non-zero coefficients, where a budget counter remBin (remainder context coded bin) is set to totalRegBin at the beginning of the residual coding of a TB (215). Outside of how the budget is initialized in step 215, the remaining process remains the same as in FIG. 1. Note that in step 215, totalRegBin is determined using Eq. (6) for R=1.75.

### Luma vs Chroma Budget Control

Problem: from Eq. (2), the same budget limit is applied for both luma and chroma, while in general luma needs more context budget than chroma. Consider a W_{L}×H_{L} transform block (TB) of non-zero output luma coefficients and two corresponding chroma blocks of size W_{C}×H_{C}. Given the current average context coded bin per absolute residual is R, which is 1.75 in VVC and ECM, then the total context coded budget is given by

totalCtxBin=floor((W_{L}*H_{L}+2*W_{C}*H_{C})*R), (7)

where, for a real number x, floor(x) is an operator of rounding down, and returns the largest integer less than or equal to x. This total budget is allocated for both luma and chroma. Proposed embodiments can handle all color formats, including 4:4:4, 4:2:0 and 4:2:2.

Proposal 2: In an embodiment, it is proposed to allocate the budget between luma and chroma by introducing an adaptive luma budget scaling factor a. The proposed context coded budget for luma is

N_{L}=W_{L}*H_{L}*R*α=W_{L}*H_{L}*R_{L}, (8)

where, the adjusted average coded bin for luma is R_{L}=R*α, where α∈[0.5, 1). Then, the remaining coded budget for each chroma channel is

$${N}_{C} = \frac{{N}_{L + C} - {N}_{L}}{2} \approx \frac{( {W}_{L} * {H}_{L} + 2 * {W}_{C} * {H}_{C} ) R - {W}_{L} * {H}_{L} * R * α}{2} = \frac{{W}_{L} * {H}_{L} * R * ( 1 - α ) + 2 * {W}_{C} * {H}_{C} * R}{2} = \frac{2 * R - {s}_{w} * {s}_{h} * ( α - 1 )}{2} {W}_{C} * {H}_{C}$$

where s_{w}=W_{L}/W_{C} and s_{H}=H_{L}/H_{C}, thus allowing to adjust N_{C} depending on the color sampling format (e.g.: 4:4:4, 4:2:0, or 4:2:2). The corresponding new ratio for each chroma channel is

R_{C}=½(2*R−s_{w}*sₕ*(α−1)).

Note: The alpha value can be fixed in both the encoder and the decoder, or it can be signaled as part of the bitstream (e.g. as depicted in Table 1). The alpha value may also depend on the bit rate. Alternatively, the alpha value could be defined using a table lookup (e.g., as shown in Table 2).

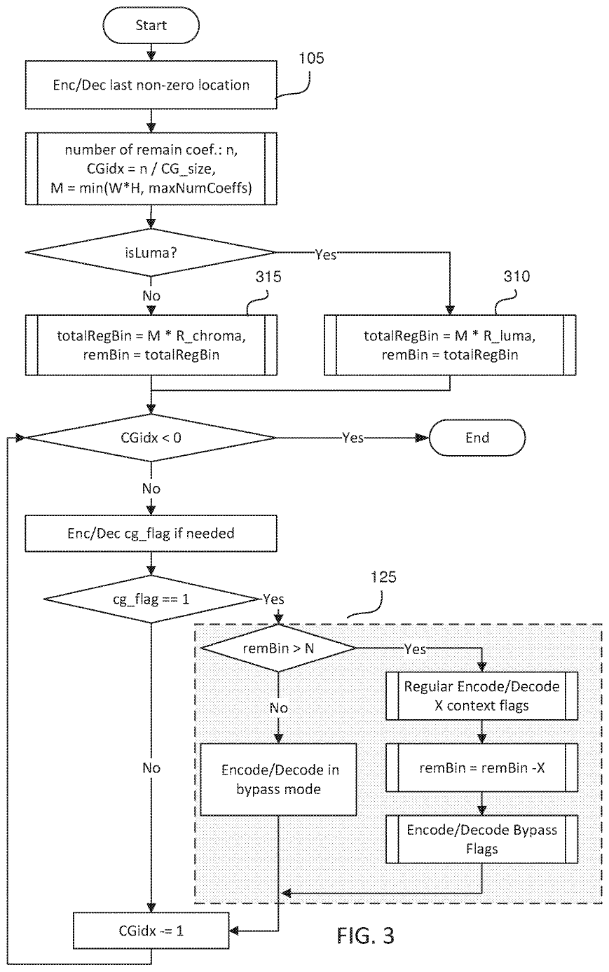

FIG. 3 depicts an example process for budget control in transform coding using luma and chroma scale factors which are denoted in steps 310 and 315 as R_luma and R_chroma. The remaining of the process is the same as in FIG. 1 and FIG. 2.

### Adaptive Budget Control

### Reserve Budget Control for the Significant Flag

Problem: given a fixed context budget of totalRegBin, adaptively allocate the context budget to maintain high coding efficiency by giving priority to the significant flag (sig).

Proposal 3: a two-tier budget is defined as follows:

totalRegBin=primaryRegBin+secondaryRegBin, (9)

where primaryRegBin is the number of context coded bins used for the conventional binarization of sig, gt_1, . . . , etc., in the first encoding pass. An additional budget is allocated for context coding of the significant flag after spending the primaryRegBin, which is denoted as secondaryRegBin.

To further constrain the budget as currently in VTM and ECM, a sig flag scaling factor αₛ∈[0, 1) is defined, such that:

primaryRegBin=floor(totalRegBin*αₛ).

secondaryRegBin=totalRegBin-primaryRegBin. (10)

In one embodiment, without limitation, αₛ is set to 0.9.

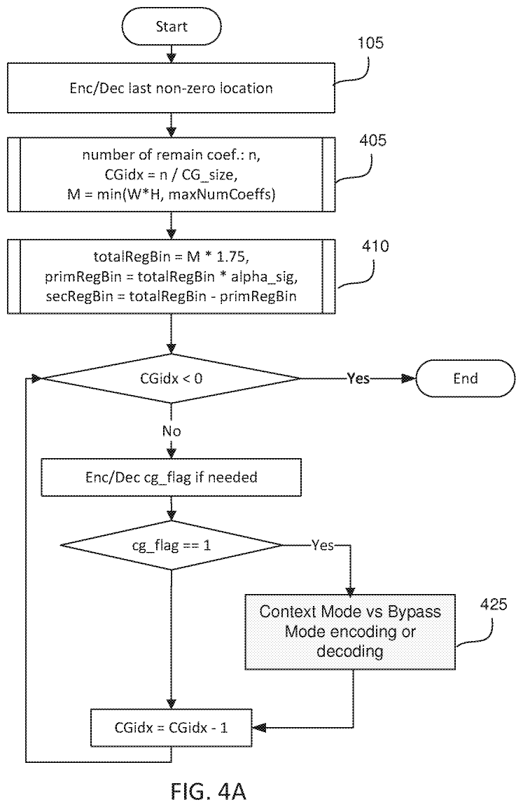

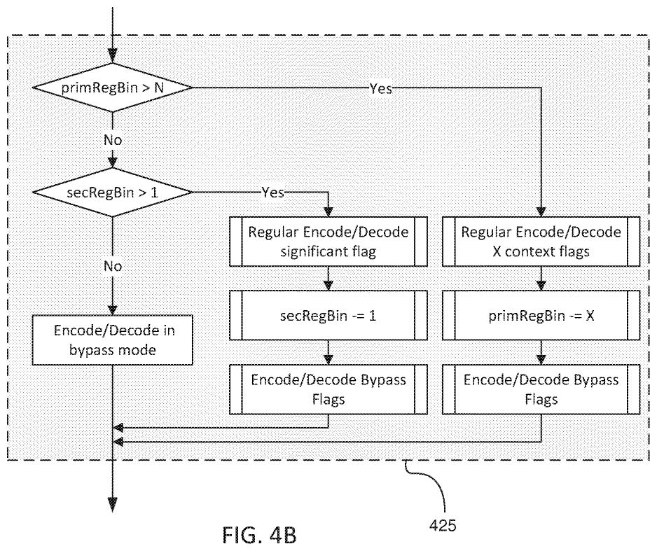

FIG. 4A and FIG. 4B depict an example process for a two-tier budget control using a sig flag scaling factor (alpha_sig). As depicted in FIG. 4, after determining the total budget (totalRegBin) (steps 405 and 410), in step 410, the total budget is split into the primary (primRegBin) and secondary (secRegBin) budgets using the sig flag (alpha_sig) scaling factor. The details of coding/decoding coefficients are depicted in step 425, shown in more detail in FIG. 4B.

As depicted in FIG. 4B, as long as primRegBin>N, the encoding/decoding process is the same as before (125). When the primary budget is depleted, then the secondary budget is used for the sig flag. When the secondary budget is depleted as well, then all coding/decoding shifts into bypass mode.

As discussed earlier, coding budget-related scaling parameters, such as a or as, can be signaled using high level syntax (HLS), such as in VPS (video parameter set), SPS (sequence parameter set), PPS (picture parameter set), PH (picture header), SH (slice header), Supplemental Enhancement Information (SEI), and the like. Table 1 depicts such an example in the SPS, with example new syntax elements shown in an Italic font.

TABLE 1
Example syntax for signaling entropy-coding
parameters in the SPS

| seq_parameter_set_rbsp( ) { | Descriptor |
|---|---|
| sps_seq_parameter_set_id | u(4) |
| sps_video_parameter_set_id | u(4) |
| . . . | |
| sps_budget_adaptation_flag | u(1) |
| if(sps_budget_adaptation_flag) { | |
| sps_budget_adaptation_prec_minus1 | ue(v) |
| sps_budget_adaptation_param | ue(v) |
| } | |
| . . . | |
| } | |

sps_budget_adaptation_flag equal to 1 specifies that an adaptive budget control is used. sps_budget_adaptation_flag equal to 0 specifies that the adaptive budget control is not used.
sps_budget_adaptation_prec_minus1 plus 1 specifies the number of bits used for the representation of the syntax sps_budget_adaption_param.
sps_budget_adaptation_param specifies the value of budget adaptation parameter in the precision of sps_budget_adaptation_prec_minus1 plus 1.

In another embodiment, one can signal budget-related scaling parameters using an index to predefined alpha values. Such an example is depicted in Table 2.

TABLE 2
Example syntax for signaling in the SPS an
entropy-coding adaptation flag

| seq_parameter_set_rbsp( ) { | Descriptor |
|---|---|
| sps_seq_parameter_set_id | u(4) |
| sps_video_parameter_set_id | u(4) |
| . . . | |
| sps_budget_adaptation_flag | u(1) |
| if(sps_budget_adaptation_flag) | |
| sps_budget_adaptation_param_id | ue(v) |
| . . . | |
| } | |

sps_budget_adaptation_param_id identifies the value for budget adaptation parameter as specified in Table 3. In an embodiment, param_id=0 may be mapped to the most frequently used scaling parameter.

TABLE 3
Example sps_budget_adaptation_
param_id values

| Value | Description |
|---|---|
| 0 | 0.9 |
| 1 | 0.95 |
| 2 | 0.85 |
| 3-7 | 0.8 |

### Priority Budget Control for the Significant Flag

Problem: proposal 3 does not provide a guarantee that the significant flags will always be context encoded.

Proposal 4. In this approach, the budget is divided into sigRegBin (a budget only for the sig flag) and nonSigRegBin (for everything else). This guarantees that the sig flag will always be encoded using a context encoding. Based on the location of last nonzero coefficient, assuming there are n coefficients to be encoded, then

sigRegBin=n. (11)

Then the nonSigRegBin is defined as:

nonSigRegBin=totalRegBin−sigRegBin. (12)

In addition, during the encoding of the coefficient group (CG), if the whole coefficient group of size CG_size coefficient is 0 (CG_size is usually 16 coefficients), the CG size number of context coded budget is moved from sigRegBin to nonSigRegBin, That is:

sigRegBin=sigRegBin−CG_size,

nonSigRegBin=nonSigRegBin+CG_size. (13)

In another embodiment, a new sig priority scaling parameter αₛₚ∈[0.5, 1) factor is introduced to restrict the priority of significant flag as sigRegBin=n*αₛₚ. This is motivated by the fact that in the case of limited budget at a small block size, and n approximately equal to W*H, then there is potentially wasted context budget. As before, αₛₚ could be signaled in the bitstream using similar approaches as before.

FIG. 5A and FIG. 5B depict an example process for preferred budget control for the sig flag. As depicted in FIG. 5A, after determining the total budget, in step 510, the total budget is split into the sig flag priority budget (sigRegBin) and the remaining budget using equations (11)-(12) and the optional αₛₚ (alpha_sp) scaling factor. During coefficient coding and decoding, in step 530, the two budgets may be adjusted using CG_size information as in Eq. (13).

As depicted in FIG. 5B, during context or bypass coding (525), as long as sigRegBin>1, the sig flag is encoded using context coding and the remaining flags use the nonSigRegBin budget as before. When all budgets are depleted, then all coding/decoding transitions to bypass mode.

### Encoding of the Parity Flag in TSRC

Problem: During Transform Skip Residual Coding (TSRC), the parity flag is always context encoded; however, there is limited correlation during encoding of the parity flag, thereby it may add little value in coding efficiency to always apply context coding for the parity flag.

Proposal 5: In this method, in TSRC, it is proposed to adaptively decide to encode the parity flag in bypass or context mode.

In an embodiment, the parity flag (par) is first encoded in context mode, but then encoding can switch to bypass mode if it is predicted that there is not enough context budget for the current transform unit (TU) after a period of encoding. For example, the period of encoding may be defined as the time after encoding of k∈[0, n) out of n TU coefficients be encoded if the remaining bin per coefficient of budget (binPerCoeff) is smaller than a given threshold. Thus, if

$$binPerCoeff = \frac{remRegBin}{( n - k )} , \qquad ( 14 )$$

is smaller than a given threshold of parThresh>0, then encoding of the parity flag is switched to bypass mode, even if there is still available context budget. For example, without limitation, k may be set to be k=round(0.5*n), with a threshold parThresh=1.0, where the function round (x) rounds x to the nearest integer.

In another embodiment, the period of encoding in context mode is defined as the time after consuming K % of the context budget (e.g., K=50%). Assuming this budget corresponds to encoding k∈[0, n) coefficients, then binPerCoeff may be calculated using Eq. 14.

In another embodiment, the parity flag is always encoded in bypass mode from the beginning instead of using context coding. This corresponds to k=0. This allows the context budget to be spent on other context-coded bins instead of being used for the parity flag. Furthermore, the total number of contexts is now being reduced, since no contexts are now associated with the parity flag in TSRC.

### REFERENCES

Each one of the references listed herein is incorporated by reference in its entirety. The term JVET refers to the Joint Video Experts Teams of ITU-T SG 16 WP 3 and ISO/IEC JTC 1/SC 29.
[1] ITU-T Rec. H.266, “Versatile Video Coding,” ITU-T, August 2020.
[2] H. Schwarz, et al., “Quantization and Entropy Coding in the Versatile Video Coding (VVC) Standard,” IEEE Transaction on Circuits and Systems for Video Technology, vol. 31, no. 10, pp. 3891-396 October 2021.
[3] P. Nikitin, et al., “EE2.3-2: Transform coefficient coding,” JVET-AG0100 JVET 33rd meeting, by teleconference, 17-26 Jan. 2024.
[4] J. Chen, et al., “EE2-4.3 related: More combined test results for sign prediction,” JVET-Y0141, JVET 25th meeting, by teleconference, 12-21 Jan. 2022.
[5] A. Browne, et al., “Algorithm description for Versatile Video Coding and Test Model 22,” JVET-AH2002, JVET 34th meeting, Rennes, 14-24 Apr. 2024.
[6] M. Abdoli, et al., “EE2-4.3: On coefficient level binarization in Transform Skip,” JVET-AL0158, JVET 38th meeting, teleconference, 26 March-4 Apr. 2025.
[7] J. Gan, et al., “EE2-related: On binarization of a coefficient level in TSRC, JVET-AL0109,” JVET 38th meeting, teleconference, 26 March-4 Apr. 2025.
[8] X. Zhao, et al., “Transform Coding in the VVC Standard”, IEEE transactions on circuits and systems for video technology, vol. 31, no. 10, October 2021.

### Example Computer System Implementation

Embodiments of the present invention may be implemented with a computer system, systems configured in electronic circuitry and components, an integrated circuit (IC) device such as a microcontroller, a field programmable gate array (FPGA), or another configurable or programmable logic device (PLD), a discrete time or digital signal processor (DSP), an application specific IC (ASIC), and/or apparatus that includes one or more of such systems, devices or components. The computer and/or IC may perform, control, or execute instructions relating to coding transform coefficients in video coding, such as those described herein. The computer and/or IC may compute any of a variety of parameters or values that relate to coding transform coefficients in video coding as described herein. The image and video embodiments may be implemented in hardware, software, firmware and various combinations thereof.

Certain implementations of the invention comprise computer processors which execute software instructions which cause the processors to perform a method of the invention. For example, one or more processors in a display, an encoder, a set top box, a transcoder, or the like may implement methods related to coding transform coefficients in video coding as described above by executing software instructions in a program memory accessible to the processors. Embodiments of the invention may also be provided in the form of a program product. The program product may comprise any non-transitory and tangible medium which carries a set of computer-readable signals comprising instructions which, when executed by a data processor, cause the data processor to execute a method of the invention. Program products according to the invention may be in any of a wide variety of non-transitory and tangible forms. The program product may comprise, for example, physical media such as magnetic data storage media including floppy diskettes, hard disk drives, optical data storage media including CD ROMs, DVDs, electronic data storage media including ROMs, flash RAM, or the like. The computer-readable signals on the program product may optionally be compressed or encrypted.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (e.g., that is functionally equivalent), including components which are not structurally equivalent to the disclosed structure which performs the function in the illustrated example embodiments of the invention.

### EQUIVALENTS, EXTENSIONS, ALTERNATIVES AND MISCELLANEOUS

Example embodiments that relate to coding transform coefficients in video coding are thus described. In the foregoing specification, embodiments of the present invention have been described with reference to numerous specific details that may vary from implementation to implementation. Thus, the sole and exclusive indicator of what is the invention, and what is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method for context-bin budget control in encoding or decoding scaled transform coefficients, the method comprising:
receiving a block of scaled transform coefficients;
processing the last non-zero scaled transform coefficient in the block of scaled transform coefficients (105);
determining a number (n) of remaining transform coefficients (110);
partitioning the remaining transform coefficients into coding groups; and
applying context-mode coding or bypass-mode coding on each of the coding groups using a context-bin budget determined based on the number of remaining transform coefficients and an initial scaling factor (R).

2. The method of claim 1, wherein computing the context-bin budget (totalRegBin) comprises
totalRegBin=n*R.

3. The method of claim 2, wherein R=1.75.

4. A method for context-bin budget control in encoding or decoding scaled transform coefficients, the method comprising:
receiving a block of scaled transform coefficients;
processing the last non-zero scaled transform coefficient in the block of scaled transform coefficients (105);
determining a number (n) of remaining transform coefficients (305);
partitioning the remaining transform coefficients into coding groups;
determining (305) a first context-bin budget parameter (M) for the coding groups;
determining a luma context-bin budget (310) based on the first context-bin budget parameter and a luma scaling factor (R_L);
determining a chroma context-bin budget (315) based on the first context-bin budget parameter and a chroma scaling factor (R_C); and
applying context-mode coding or bypass-mode coding on each of the coding groups, wherein, if the coding group is a luma coefficients group, then applying the luma context-bin budget, else applying the chroma context-bin budget.

5. The method of claim 4, wherein computing the luma context-bin budget (totalRegBin) comprises computing
totalRegBin=M*R_{L},
where R_{L}=R*α_{L}, where R=1.75, and α_{L}∈[0.5, 1).

6. The method of claim 5, wherein the luma scaling factor is communicated from an encoder to a decoder using high level syntax.

7. The method of claim 6, wherein the high level syntax includes a syntax parameter to determine α_{L} either explicitly or via an index to a lookup table.

8. The method of claim 4, wherein M=n or
M=min(W*H,maxNumCoeffs),
wherein W and H denote width and high of the block of scaled transform coefficients, and maxNumCoeffs denotes the maximum number of coefficients in the maximum transform block size.

9. A method for context-bin budget control in encoding or decoding scaled transform coefficients, the method comprising:
receiving a block of scaled transform coefficients;
processing the last non-zero scaled transform coefficient in the block of scaled transform coefficients (105);
determining a number (n) of remaining transform coefficients (110);
partitioning the remaining transform coefficients into coding groups;
determining (410) a first context-bin budget (totalRegBin) for the coding groups;
splitting the first context-bin budget into a primary context-bin budget and a secondary context-bin budget;
and
applying context-mode coding or bypass-mode coding (425) on each of the coding groups using the primary context-bin budget and the secondary context-bin budget.

10. The method of claim 9, wherein determining the first context-bin budget (totalRegBin) comprises computing:
M=n or
M=min(W*H,maxNumCoeffs),
totalRegBin=M*R,
wherein W and H denote width and high of the block of scaled transform coefficients, maxNumCoeffs denotes the maximum number of coefficients in the maximum transform block size, and R is a scaling factor.

11. The method of claim 9, wherein applying context-mode coding or bypass-mode coding (425) on each of the coding groups using the primary context-bin budget and the secondary context-bin budget further comprises:
if the primary context-bin budget is above a threshold (N), then
applying context-mode coding or bypass-mode coding;
else, if the secondary context-bin budget is larger than 1, then
applying context-mode coding to significant flags only and reducing the secondary context-bin budget by one when processing a significant flag;
else switching to applying bypass-mode only.

12. The method of claim 9, wherein splitting the first context-bin budget (totalRegBin) into a primary context-bin (primaryRegBin) budget and a secondary context-bin budget (secRegBin) comprises computing:
primaryRegBin=floor(totalRegBin*αₛ),
secRegBin=totalRegBin−primaryRegBin,
wherein αₛ denotes a significant flag scaling factor and floor(x) returns the largest integer less than or equal to x.

13. The method of claim 12, wherein the significant flag scaling factor is communicated from an encoder to a decoder using high level syntax.

14. The method of claim 9, wherein splitting the first context-bin budget (totalRegBin) into a primary context-bin (sigRegBin) budget and a secondary context-bin budget (nonSigRegBin) comprises computing
sigRegBin=n*αₛₚ,
nonSigRegBin=totalRegBin−primaryRegBin,
wherein αₛₚ∈[0, 1).

15. The method of claim 9, wherein applying context-mode coding or bypass-mode coding (425) on each of the coding groups using the primary context-bin budget and the secondary context-bin budget further comprises:
if the primary context-bin budget is larger than 1 then
applying context-mode coding to process significant flags and reducing the primary context-bin budget by one when processing each significant flag;
else applying bypass-mode coding to process the remaining significant flags;
for coded group parameters, excluding a significant flag:
if the secondary context-bin budget is above a threshold (N−1), then
applying context-mode coding or bypass-mode coding and adjusting the secondary context-bin budget;
else switching to applying bypass-mode only.

16. The method of claim 14, further comprising, if a coding group has all zero coefficients, then
sigRegBin=sigRegBin−CG_size,
nonSigRegBin=nonSigRegBin+CG_size,
wherein CG_size denotes the size of the coding group.

17. A method for context-bin budget control in encoding or decoding scaled transform coefficients, the method comprising:
in Transform Skip Residual Coding (TSRC), applying bypass mode to encode or decode all remaining parity flags after encoding or decoding k∈[0, n) out of n transform unit coefficients in context mode, when:
$$K = 0 ; or$$
$$\frac{remRegBin}{( n - k )} < thr 1 ; or$$
$$remRegBin < thr 2 ,$$
wherein remRegBin denotes a remaining context budget after processing the k transform unit coefficients in context mode, and thr1 and thr2 are thresholds.

18. The method of claim 17, wherein k=round (0.5*n), thr1=1.0, and thr2=50% of a total initial context budget.

19. A tangible computer-readable storage medium having stored thereon computer-executable instructions for executing with one or more processors a method in accordance to the method recited in claim 1.

20. An apparatus comprising a processor and configured to perform the method recited in claim 1.
